(19) United States
(12) Patent Application Publication
(10) Pub. No.: US 2011/0294315 A1
(43) Pub. Date: Dec. 1, 2011

(54) CIRCUIT BOARD MODULE AND ELECTRONIC DEVICE PROVIDED WITH THE SAME

(75) Inventors: Masahito Kawabata, Kanagawa (JP); Seiji Yamaguchi, Tokyo (JP)

(73) Assignee: PANASONIC CORPORATION, Osaka (JP)

(21) Appl. No.: 13/147,939

(22) PCT Filed: Nov. 17, 2009
(86) PCT No.: PCT/JP2009/006174

§ 371 Date: Aug. 4, 2011

(30) Foreign Application Priority Data
Feb. 26, 2009 (JP) 2009-043705

(51) Int. Cl. H01R 12/71

(52) U.S. Cl. 439/81

(57) ABSTRACT

Provided are a circuit board module and an electronic device provided with the same capable of increasing the strength of a card connector, with the configuration that the card connector is mounted to have a specific space from the board. The circuit board module is provided with a card connector portion 40 which includes a card insertion port from which a card C1 having at least one contact is inserted, and a housing chamber 42 which is formed to be communicated with the card insertion port to contain the card C1 therein; and a circuit board 10 having a surface which supports the card connector portion 40. The card connector portion 40 is provided with a spring contact portion which projects from a floor surface of the card connector which forms the housing chamber 42 at a side of the circuit board 10 into the housing chamber 42, and contacts the contact of the card C1 to secure the electrical connection with the contact, and at least one column member 31A is provided in a mount space S formed between the surface of the circuit board 10 and the card connector portion 40 so that the column member at least partly overlaps a beginning area which corresponds to a root portion of the spring contact portion which projects into the housing chamber 42.

### TECHNICAL FIELD

The present invention relates to a circuit board module equipped with a card connector used to read and/or record information of a memory card which is inserted into a card slot, and an electronic device provided with the same.

### BACKGROUND ART

In electronic devices including the personal computer and its peripheral equipments, etc., a small memory card of miniature size (concretely, SD card, MS card, or the like, and such small memory card is referred simply to as the “memory card” hereinafter) fulfills an important role as the memory device for storing the information. This memory card is connected electrically to the electronic device, e.g., the main body side of a mobile terminal device, or the like, via the card connector.

As an example of the above card connector, a card connector has been already known that includes a housing, which is made of insulating material and has a space that extends longitudinally in connection with a forward-opened card insertion port, and a plurality of contacts, which are attached to the housing and each one end of which projects into the space. The card connector is constructed to receive and hold the rectangular memory card, which is inserted into the space through the card insertion port, such that planar card-side terminals provided to the memory card are brought into contact with one ends of the contacts with pressure respectively, and also is secured to a board by screws or fixed to the board with solder.

Also, with the progress of higher performance in the above electronic device, in order to increase a mount density of components by utilizing effectively a limited board surface, the card connector with standoff being constructed such that a clearance is formed between a lower surface of the housing (a surface on the board side) and the board surface and electronic components such as IC chip is mounted therein has been proposed (see Patent Literature 1, for example).

That is, as shown in FIG. 11, a card connector 100 with standoff includes a housing 100A made of insulating material and having a card receiving space being opened to the front end side and a plurality of contacts 110 that protrude into the card receiving space, and also is constructed to receive a rectangular planar memory card 200 inserted into the card receiving space such that planar card-side terminals 210 provided to the memory card 200 are brought into contact with one ends of the contacts 110 with pressure respectively. Also, the card connector 100 includes a first shield member 120 and a second shield member 130 made of metal material to cover the housing 100A, and standoff portions 140, 150 extended downwardly beyond a lower surface of the housing 100A from both left and right sides of the first shield member 120. The standoff portions 140, 150 are jointed to a board 160 to which the card connector 100 is attached, and thus a clearance is formed between the housing 100A and the board 160.

### CITATION LIST

### Patent Literature

Patent Literature 1: JP-A-2006-324185

### SUMMARY OF THE INVENTION

### Technical Problem

Meanwhile, in the electronic device equipped with such card connector, a miniaturized electronic device being suitable especially for a mobile use, or the like has been known. Accordingly, when such card connector is attached to the mobile phone, or the like, for example, the card connector side has a fragile structure because this connector is supported on the main body merely by the standoff portions. Therefore, when a strong impact is applied, e.g., when a user drops a cell phone by mistake during carrying it, such strong impact is applied to concentrate upon the standoff portions, and the standoff portions may be broken down or damaged.

The present invention has been made in view of the above circumstances, and it is an object of the present invention to provide a circuit board module, which is capable of enhancing strength of a card connector and also keeping stably a connection to a memory card being inserted into the card connector even when such a structure is employed that a card connector should be attached to provide a predetermined space on a board, and an electronic device provided with the same.

### Solution to Problem

A circuit module according to an aspect of the invention is configured to include: a card connector which includes a card insertion port from which a card having at least one contact is to be inserted, and a housing chamber which is formed to be communicated with the card insertion port to contain the card therein; and a circuit board having a surface which supports the card connector, wherein the card connector includes a spring contact portion which projects from a surface of the card connector which forms a space of the housing chamber into the space of the housing chamber at a side of the circuit board, and is constructed to contact the contact of the card to secure electrical connection with the contact, and at least one column member is provided in a space formed between the surface of the circuit board and the card connector so that the column member at least partly and substantially overlaps a beginning area corresponding to a root portion of the spring contact portion.

According to the above configuration, the strength is ensured by providing the column member. Therefore, even when the card connector is bent by an application of the impact, or the like, the spring contact portion is hardly bent, and thus a contacting state of the spring contact portion to the contact of the card can be stably maintained.

An electronic component may be mounted between the surface of the circuit board and the card connector.

According to the above configuration, a mount density of the components on the circuit board can be increased.

The circuit module may further include an electrical connecting member which includes a first surface that faces to the card connector, and a second surface that faces to the surface of the circuit board, the electrical connecting member electrically connecting the spring contact portion and the circuit board.

According to the above configuration, not only an improvement of the strength but also the electrical connection between the spring contact portion and the circuit board can be achieved. Also, the column member and the electrical connecting portion may be formed integrally with each other.

An electronic component may be disposed between the circuit board and a part of the column member.

According to the above configuration, a mount density of the components on the circuit board can be increased further more.

The circuit module may further include a connector board which is provided between the card connector and the circuit board, and faces to a surface of the column member at a side of the card connector.

The connector board is electrically and mechanically connected to the card connector, and is also electrically and mechanically connected to the circuit board.

According to the above configuration, the connection between the column member and the card connector is facilitated.

A metallic member may be provided on each of a first surface and a second surface of the column member, the first surface facing to the connector board, and the second surface facing to the circuit board. The metallic member on the first surface is connected to the connector board via a solder, and the metallic member on the second surface is connected to the circuit board via a solder. A metallic member may be also provided on a third surface of the column member that connects the first surface and the second surface. The configuration may be adopted so that a metallic member is also provided on a fourth surface of the column member that connects the first surface and the second surface, and at least a part of a cross-section of the column member in its longitudinal direction is surrounded with the metallic member.

According to the above configuration, the strength of the column member can be improved, and the contact between the spring contact portion and the contact of the card can be held stably.

The electronic device equipped with the above circuit board module is also contained in the present invention.

### ADVANTAGEOUS EFFECTS OF THE INVENTION

The circuit board module according to the aspect of the present invention can ensure the strength by providing the column member, and is constructed particularly such that the root of the spring contact portion of the card connector is positioned below the column member. Even when the card connector is bent by an application of the impact, or the like, e.g., when the user drops the electronic device equipped with the circuit board module, the spring contact portion is hardly bent, and thus a contacting state of the spring contact portion to the contact of the card can be stably maintained.

### BRIEF DESCRIPTION OF THE DRAWINGS

FIG. 1 is a cross-sectional view of a circuit board module taken along a line I-I of FIG. 4, the circuit board module being provided with a mobile phone, a kind of an electronic device according to a first embodiment of the present invention.

FIG. 2 is a cross-sectional view of the circuit board module taken along a line II-II of FIG. 4.

FIG. 3 is a cross-sectional view of the circuit board module taken along a line of FIG. 4.

In FIG. 4, (A) is a bottom view of a relay connector portion of the circuit board module, and (B) is a side view of the relay connector portion.

In FIG. 5, (A) to (C) are cross-sectional views showing respective aspects of a column member and an electrical connecting member of the relay connector portion of the circuit board module.

In FIG. 6, (A) and (B) are illustrative view showing a card connector portion of the circuit board module.

FIG. 7 is a bottom view of a relay connector portion of a circuit board module according to a second embodiment of the present invention.

FIG. 8 is an illustrative view showing a card connector portion of the circuit board module.

FIG. 9 is a cross-sectional view of a circuit board module according to a third embodiment of the present invention.

FIG. 10 is a cross-sectional view of a circuit board module according to a fourth embodiment of the present invention.

FIG. 11 is a cross-sectional view showing a standoff card connector in a related art.

### DESCRIPTION OF THE EMBODIMENTS

Embodiments of the present invention will be explained in detail with reference to the accompanying drawings hereinafter.

### First Embodiment

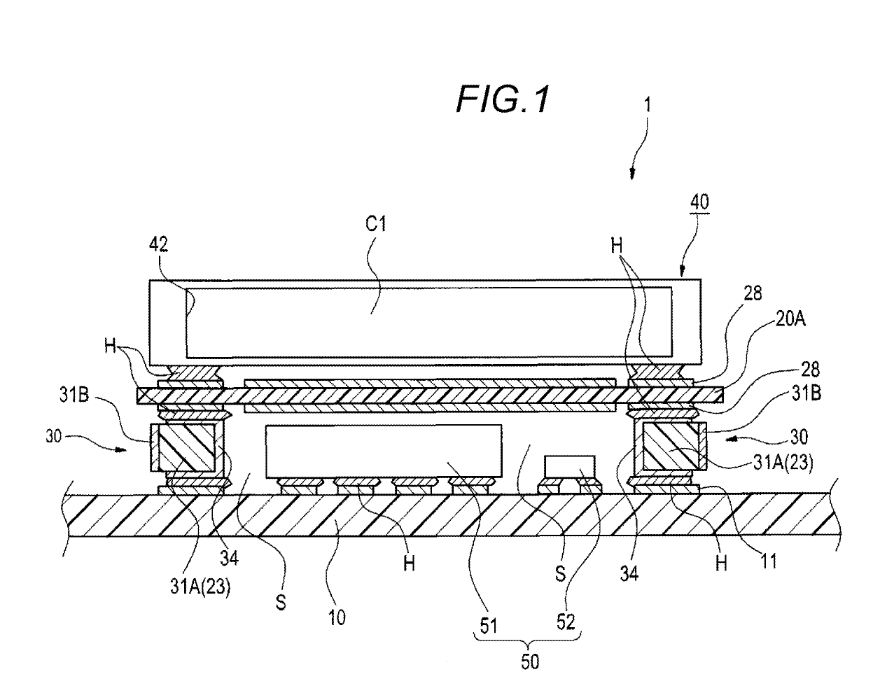

FIG. 1 shows a circuit board module 1 according to a first embodiment of the present invention, which is installed into an electronic device such as a mobile phone. The circuit board module 1 includes a circuit board 10, a connector board 20A, relay connector portions 30 constituting standoff portions respectively, a card connector portion 40, and an electronic component 50 mounted in a mount space S formed between the circuit board 10 and the connector board 20A.

In the present embodiment, the circuit board 10 supports the card connector portion 40 on one surface (in FIG. 1, an upper surface, and the upper surface is referred to as the “surface” hereinafter) via the relay connector portions (standoff portions) 30 and the connector board 20A. Also, the electronic component 50 is mounted on the circuit board 10, and a liquid crystal display device (LCD) (not shown), etc. are mounted on an opposite surface.

Meanwhile, the connector board 20A has a first surface (referred to as an “upper surface” hereinafter) that faces to the card connector portion 40, and a second surface (referred to as a “lower surface” hereinafter) that faces to a surface of the circuit board 10. The relay connector portions 30 are located between the lower surface of the connector board 20A and the surface of the circuit board 10, and have electrical connecting portions 34 each of which electrically connects a spring contact portion 43, described later, located on a side of the card connector portion 40 and the circuit board 10 respectively.

In order to increase a mount density of the electronic components 50 by utilizing effectively the limited surface of the circuit board 10, the relay connector portions 30 form the mount space S as a clearance between the surface of the connector board 20A (the surface on the board side) and the surface of the circuit board 10. That is, the relay connector portion 30 has so-called standoff function to isolate the connector board 20A from the circuit board 10.

The relay connector portion 30 in the present embodiment has a column member 31A formed of a column-like resin that is provided to stand upright toward the lower surface of the connector board 20A from the circuit board 10. As shown in FIG. 4, the column member 31A is constructed by a resin layer 23 (referred to as a “peripheral resin layer” hereinafter) that is shaped to have a square shape along the outer edge side, when viewed from the top, and a resin layer 24 (referred to as a “center resin layer” hereinafter) for connecting both left and right side portions corresponding to two sides of the peripheral resin layer 23 like a beam on the lower surface side of the connector board 20A.

The electrical connecting portions (electrode lands) 34 formed of metal material constituting a part of signal lines are secured to the column member 31A on upper and lower surfaces of two sides of the peripheral resin layer 23 of the column member 31A and one side surface that connects the upper and lower surfaces. The electrical connecting portion 34 has a U-shaped cross-section, and an upper surface and a lower surface thereof are connected to a wiring pattern 28 on the connector board 20A and a wiring pattern 11 on the circuit board 10 via a solder H, respectively. Therefore, the electrical connecting portions 34 connect electrically the circuit board 10 and the connector board 20A. Also, the electrical connecting portions 34 perform the function to improve strength of the column member 31A.

A metal member 31B is secured integrally with the column member 31A, on one side surface, onto which the electrical connecting portions 34 are not provided, of the peripheral resin layer 23 of the column member 31A. The metal member 31B performs the function to improve strength of the column member 31A. Also, as shown in (A) of FIG. 4, the metal member 31B is formed to surround the full circumference of the peripheral resin layer 23. Accordingly, the metal member 31B performs the function of shielding an inner space of the peripheral resin layer 23.

Also, a dummy land 22 made of metal member is formed at four corners of the peripheral resin layer 23 of the column member 31A, respectively. An upper surface and a lower surface of the dummy land 22 are connected to a dummy land 29 of the connector board 20A and a dummy land 10A of the circuit board 10 via the solder H, respectively. The dummy lands 22 perform the function to improve strength of the column member 31A.

Also, a securing layer 25 made of metal member is secured to the full circumference at three locations of the center resin layer 24 in the column member 31A in the longitudinal direction respectively. The securing layer 25 has a square-shape having an opening in its center in cross-section, and an upper surface and a lower surface thereof are connected to the dummy land 29 on the connector board 20A and the dummy land 10A on the circuit board 10 via the solder H, respectively. The securing layers 25 perform the function to improve strength of the column member 31A.

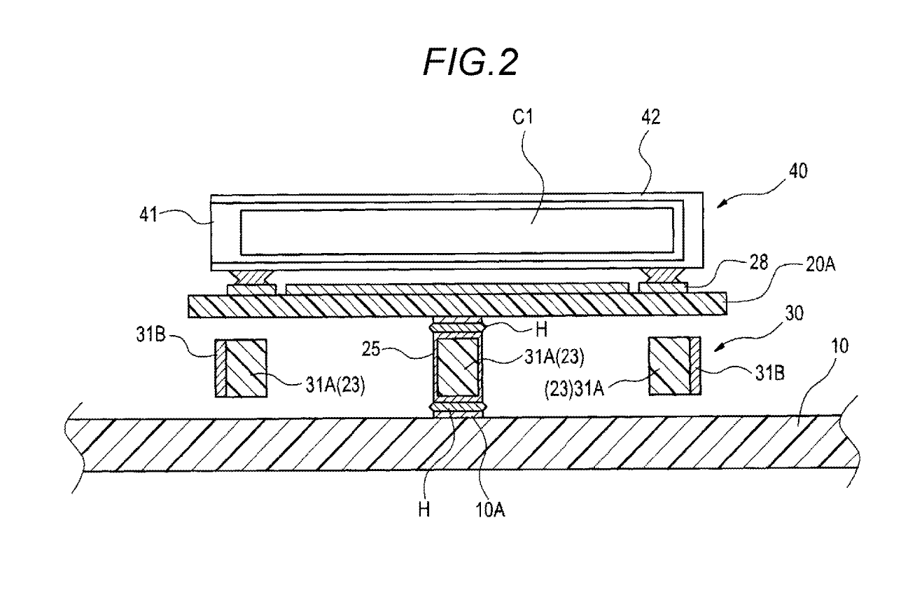

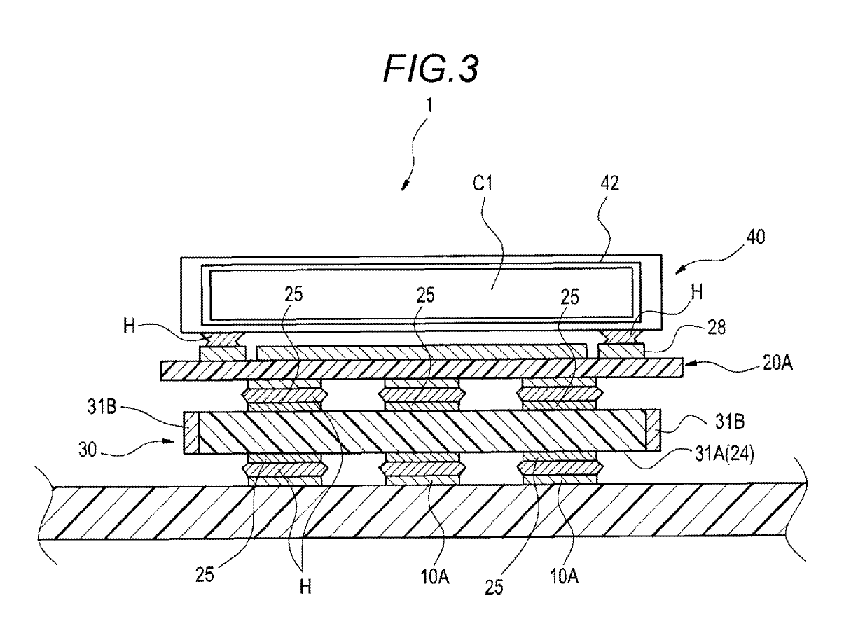

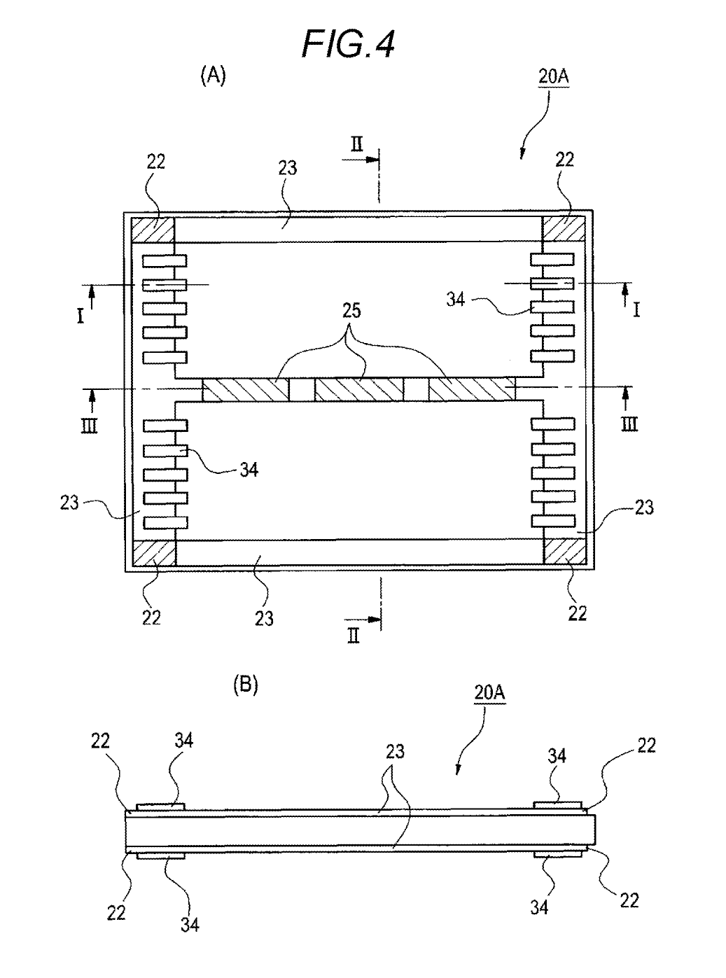

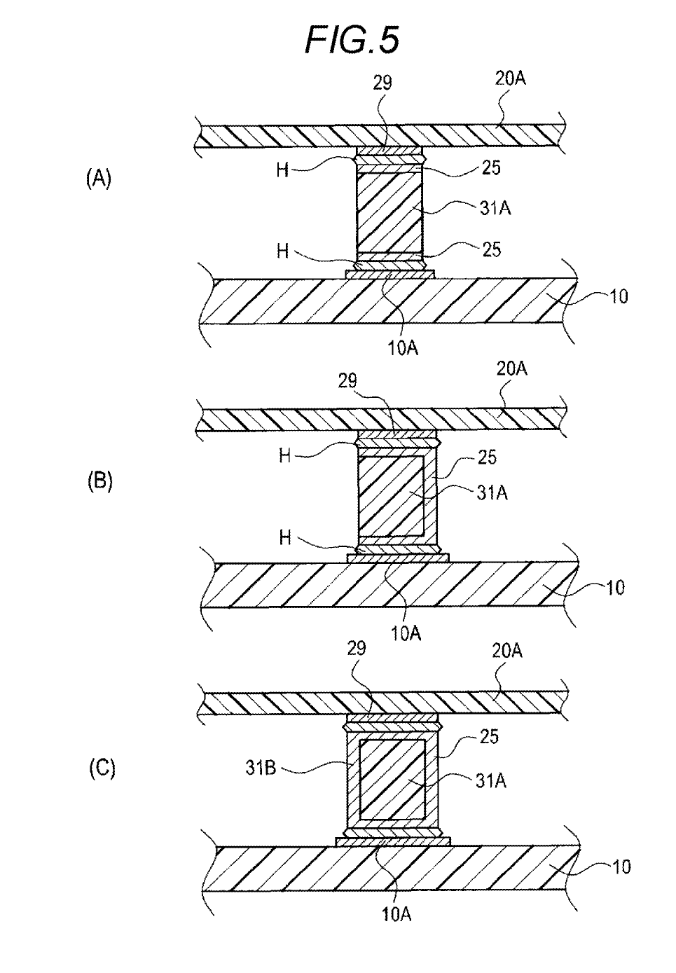

As shown in FIG. 2, the card connector portion 40 has a card insertion port 41 from which a card C1 (having at least one contact) (see FIG. 6), and a housing chamber 42 formed in communication with the card insertion port 41 to contain the card C1 therein. Also, the card connector portion 40 has the spring contact portions 43, which are projected obliquely (in FIG. 1, projected upwardly) into the housing chamber 42 from one surface (in FIG. 1, an upper surface; a floor surface) of the connector board 20A side to come into contact with the contacts of the card C1 to secure the electrical connection, in the housing chamber 42. In this case, the UIM card (User Identity Module Card) such as the SIM card (Subscriber Identity Module Card) having six contacts P can be employed as the card C1. In the present embodiment, for the sake of simplicity of explanation, the number of contacts P is set to three.

Further, the portion constructed by the center resin layer 24 in the above column member 31A is positioned just below the root portions of the spring contact portions 43 that come into contact with the contacts P of the card Cl. Concretely, as shown in (A) and (B) of FIG. 6, three portions of the center resin layer 24, onto which the securing layer 25 is secured, in the column member 31A are provided so that these portions at least partly overlaps a part of areas (beginning areas) corresponding to the root portions (in (A) of FIG. 6, cross-hatched parts a) of three spring contact portions 43 that are projected obliquely into the inner side (in (A) of FIG. 6, the surface side of the sheet) of the housing chamber 42 from the lower surface of the housing chamber 42 respectively. In another case, the securing layers 25 of the column member 31A may be provided not to overlap with the beginning areas but to shift slightly from the beginning areas respectively. Therefore, the securing layers 25 of the column member 31A may be provided to overlap substantially with the beginning areas respectively.

Also, a fixing portion R for fixing the spring contact portion 43 to a lower surface of the housing chamber 42 is provided in the beginning area. The fixing portion R can be molded integrally with the housing chamber 42 by the same resin to surround the spring contact portion 43. The fixing portion R corresponding to the beginning area is provided so as to overlap substantially with the securing layer 25 of the column member 31A, and the fixing portion R of the spring contact portion 43 can be supported by the column member 31A. Therefore, the column member 31A can generate effectively a stress via the substantially overlapped fixing portion R against an impact applied to the spring contact portion 43.

As described above, because the relay connector portion 30 constructed by the column member 31A is provided between the circuit board 10 and the card connector portion 40, a predetermined strength of the card connector portion 40 can be ensured. In particular, the root portions of the spring contact portions 43 of the card connector portion 40 are arranged just on the column member 31A. Therefore, even though the card connector portion 40 is bent when the user drops the cellular phone by mistake, or the like, not only the column member 31A but also the circuit board 10 side through the column member 31A can receive the impact. Since the column member 31A supports the surrounding portions of the spring contact portions 43, the card connector portion 40 is hardly bent and also the contact state between the contacts on the card C1 side and the card connector portion 40 is hardly disconnected. As a result, the conductive state between the circuit board 10 and the card C1 can be maintained and ensured without fail.

The portion of the column member 31A where the securing layer 25 is formed will be explained with reference to FIG. 5 hereunder. In the present embodiment, as shown in (C) of FIG. 5, the securing layer 25 made of metal member is secured integrally with the whole outer peripheral surface of the column member 31A whose cross-section is shaped substantially into a square column, i.e., is secured to cover both upper and lower surface portions and the side surface portions. The strength of the column member 31A is improved much more by the securing layer 25, and thus the card connector portion 40 is hardly bent. In particular, the securing layer 25 is provided to at least partly overlap the root portions of the spring contact portions 43. Therefore, the contact state between the spring contact portions 43 and the contacts on the card C1 side can be kept satisfactorily, and the troubles such as the break of the electrical contact between the card C1 and the circuit board 10 can be avoided.

Here, as the column member 31A in the present embodiment, the structure shown in (C) of FIG. 5 is employed. In this case, although the strength is slightly inferior, a structure shown in (A) or (B) of FIG. 5, for example, may be employed. That is, in the example in (A) of FIG. 5, the securing layer 25 as the metal member is provided to a first surface (upper surface) of the column member 31A opposing to the connector board 20A and a second surface (lower surface) opposing to the circuit board 10 respectively. The securing layer 25 on the first surface is joined to the connector board 20A via the solder H, and the securing layer 25 on the second surface is joined to the circuit board 10 via the solder H.

In the example in (B) of FIG. 5, the securing layer 25 is also provided to a third surface (right side surface) of the column member 31A that connects the upper and lower surfaces of the column member 31A. In the example in (C) of FIG. 5 as the embodiment, the securing layer 25 is also provided to a fourth surface (left side surface) that connects the upper and lower surfaces of the column member 31A. Then, such a situation is constructed that the sections of the column member 31A in the longitudinal direction are surrounded with the securing layer 25.

The electronic component 50 is mounted by utilizing the mount space S as the spatial area between the card connector portion 40 on the surface of the circuit board 10 and the connector board 20A. In this case, as the electronic component 50, for example, SMD (Surface-Mounted Device) such as a semiconductor package component 51, an LCR circuit chip component 52 is employed, and is mounted on the surface of the circuit board 10.

### Second Embodiment

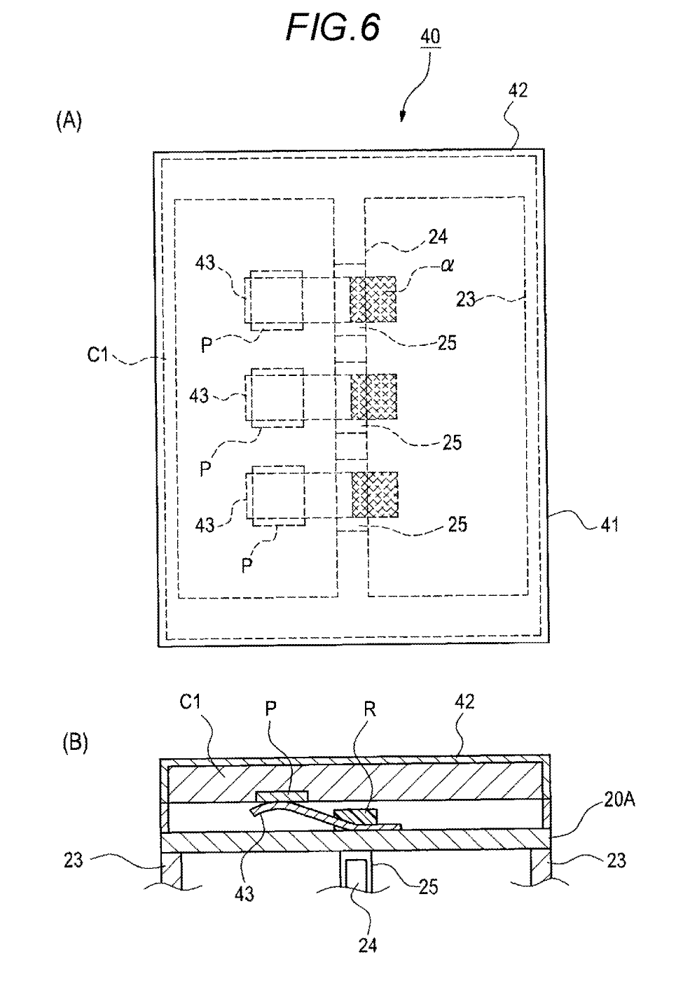

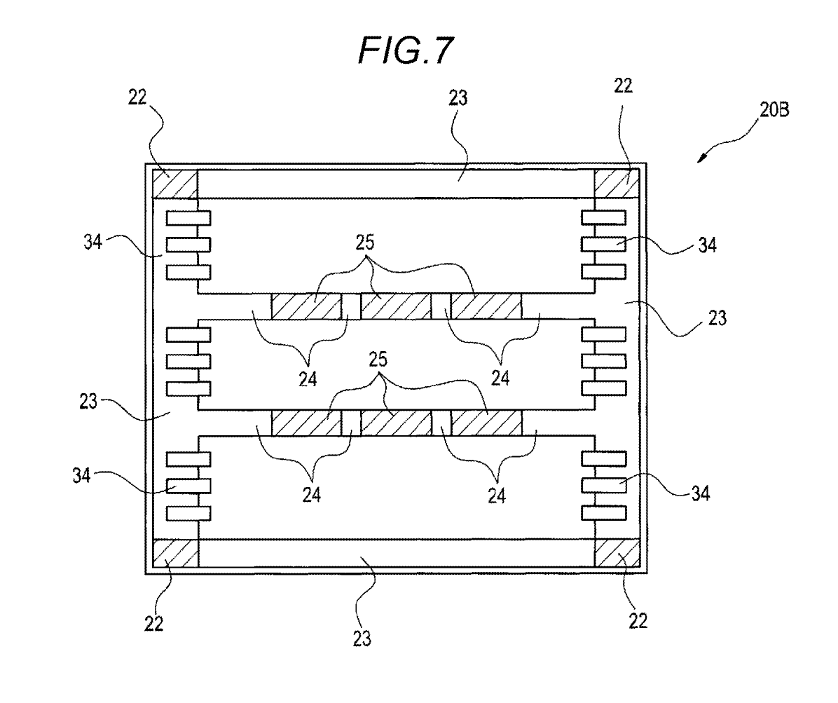

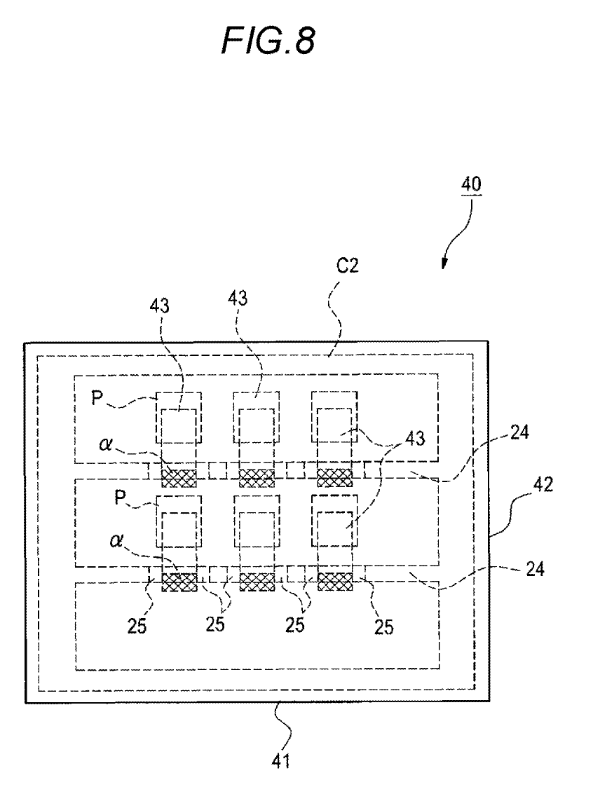

Next, a second embodiment of the present invention will be explained in detail with reference to FIG. 7 and FIG. 8 hereunder. Here, in the present embodiment, the redundant explanation will be avoided by affixing the same reference symbols to the same portions as those in the first embodiment.

In the second embodiment of the present invention, as shown in FIG. 7, such a structure is employed that the beam-like center resin layer 24 is provided in two lines (or two lines or more) instead of one line. Also, in the present embodiment, as shown in FIG. 8, a card C2 having such a structure that the contacts P are provided at three locations in two lines respectively, i.e., at six locations in total, on the back surface is employed.

In a connector board 20B of the present embodiment, as shown in FIG. 7, the securing layer 25 for fixing the column member 31A of the relay connector portion 30 between the center resin layers 24 is provided at plural locations (in the present embodiment, three locations) along the center resin layer 24 in respective lines.

### Third Embodiment

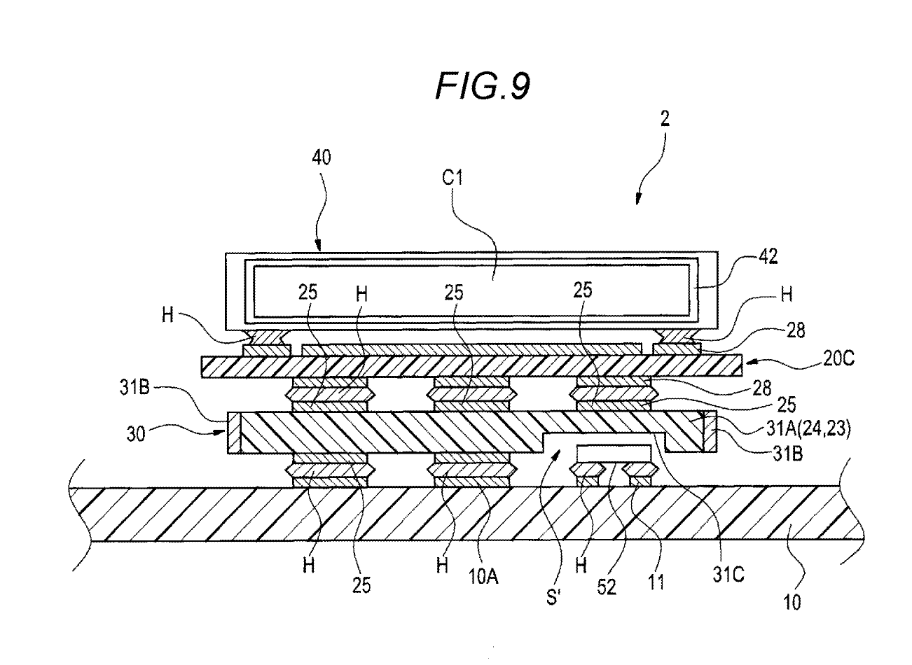

Next, a third embodiment of the present invention will be explained in detail with reference to FIG. 9 hereunder. Here, in the present embodiment, the redundant explanation will be avoided by affixing the same reference symbols to the same portions as those in the first and second embodiments.

In the third embodiment of the present invention, a partial area 31C of column member 31A, which connects a connector board 20A provided in a circuit board module 2 and the circuit board 10, is formed narrowly in width in the height direction. Also, a mount space S′ whose height is low is formed between the partial area 31C and the circuit board 10. Then, the small height component, e.g., the LCR circuit chip component 52, is arranged in the mount space S′, and is mounted on the circuit board 10 by utilizing the mount space S′. Therefore, according to the present embodiment, not only an improvement of the strength of the connector board 20C but also a further increase of the mount density of components can be achieved.

### Fourth Embodiment

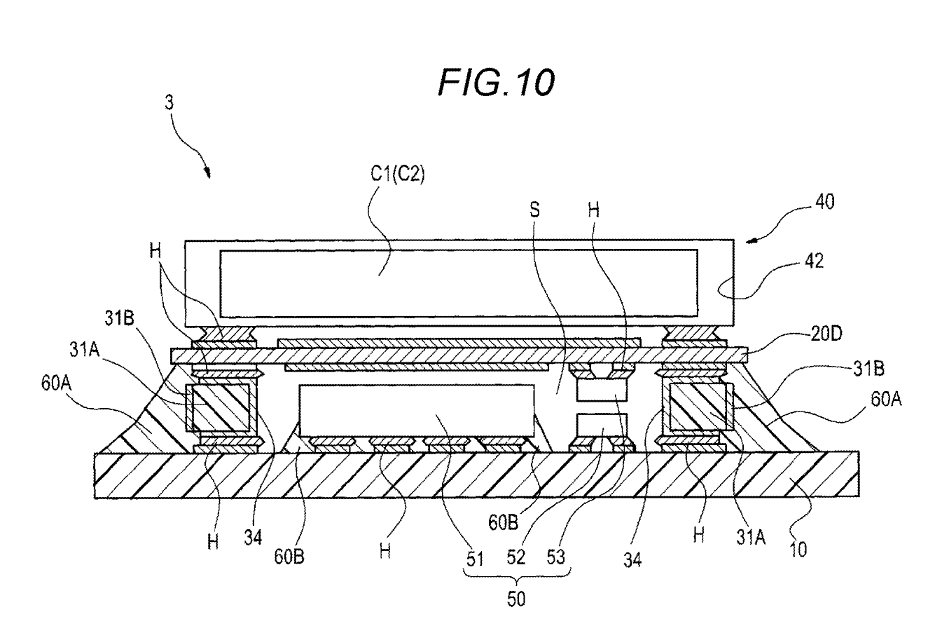

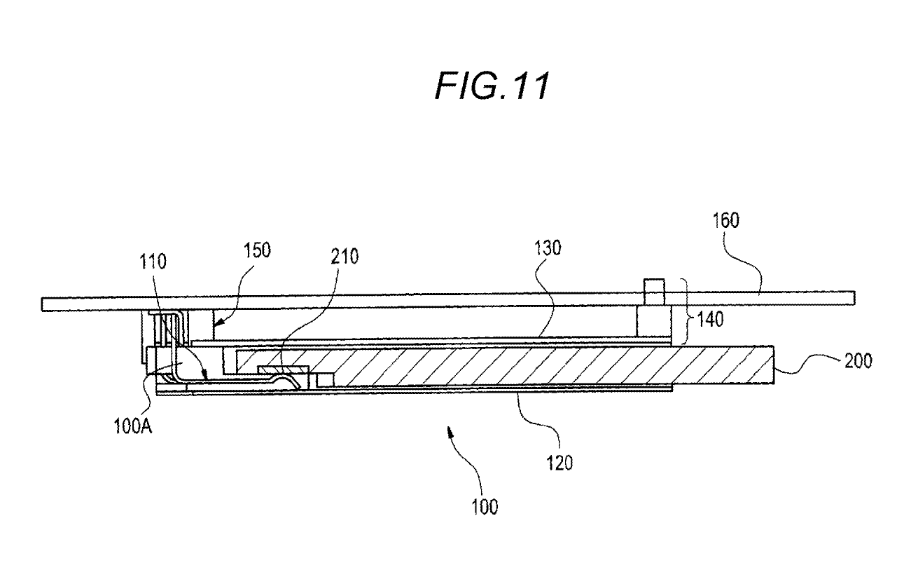

Next, a fourth embodiment of the present invention will be explained in detail with reference to FIG. 10 hereunder. Here, in the present embodiment, the redundant explanation will be avoided by affixing the same reference symbols to the same portions as those in the first to third embodiments.

In the fourth embodiment of the present invention, side surfaces of a circuit board module 3 are sealed with a sealing member 60A such as a resin, and also the semiconductor package component 51, and the like are reinforced with a sealing member 60B.

Also, in a connector board 20D, an electronic component 53 is mounted on the lower surface side by utilizing the mount space S. Accordingly, a mount density of components can be increased further more. This mode can be applied to the case in the first and second embodiments.

In respective embodiments of the present invention explained above, the connector boards 20A to 20D are provided respectively. But these connector boards 20A to 20D are not particularly indispensable to the present invention. Such a configuration may be employed that the card connector portion 40 is provided directly to the circuit board 10 via the relay connector portion 30 containing the column member 31A.

With the above, various embodiments of the present invention are explained, but the present invention is not limited to the matters illustrated in the above embodiments. The present invention is susceptible to the variations and the applications, which are made by those skilled in the art based on the description of the specification and the well-known technology and are contained in a scope within which a protection is sought.

This application is based upon Japanese Patent Application No. 2009-043705, filed on Feb. 26, 2009; the contents of which are incorporated herein by reference.

### INDUSTRIAL APPLICABILITY

According to the present invention, the strength of the card slot portion can be ensured and increased even in the configuration that the card slot portion is attached while holding a predetermined space on the board, and also the present invention is applicable to the electronic device with the circuit board module, e.g., the mobile terminal device such as the cellular phone, PHS, PDA.

### Reference Signs List

1, 3: Circuit board module
10: Circuit board
10A: Dummy land
20A, 20B, 20D:Connector board
22: Dummy land
23: Peripheral resin layer
24: Center resin layer
25: Securing layer (metallic material)
30: Relay connector portion
31A: Column member
31B: Metal member
34: Electrical connecting member
40: Card connector portion
41: Card insertion port
42: Housing chamber
43: Spring contact portion
50: Electronic component
51: Semiconductor package component
52: LCR circuit chip component
60A, 60B: Sealing member
C1, C2: Card
H: Solder
P: Contact
R: Fixing portion
S, S′: Mount space
α: Root portion of spring contact portion

1. A circuit module, comprising:
a card connector which includes a card insertion port from which a card having at least one contact is to be inserted, and a housing chamber which is formed to be communicated with the card insertion port to contain the card therein;
a circuit board having a surface which supports the card connector;
a spring contact portion which projects from a surface of the card connector which forms a space of the housing chamber into the space of the housing chamber at a side of the circuit board of the card connector, and is constructed to contact the contact of the card to secure electrical connection with the contact;
an electrical connecting member which includes a first surface that faces to the card connector, and a second surface that faces to the surface of the circuit board, the electrical connecting member electrically connecting the spring contact portion and the circuit board; and
at least one column member which is provided in a space formed between the surface of the circuit board and the card connector so that the column member at least partly and substantially overlaps a beginning area corresponding to a root portion of the spring contact portion, and which is integrally formed with the electrical connecting member.

2. The circuit module according to claim 1, wherein
an electronic component is mounted between the surface of the circuit board and the card connector.

3-4. (canceled)

5. The circuit module according to claim 4, wherein
an electronic component is disposed between the circuit board and a part of the column member.

6. The circuit module according to claim 1, wherein
the circuit module further comprises a connector board which is provided between the card connector and the circuit board, and faces to a surface of the column member at a side of the card connector.

7. The circuit module according to claim 6, wherein
the connector board is electrically and mechanically connected to the card connector, and is also electrically and mechanically connected to the circuit board.

8. The circuit module according to claim 7, wherein
a metallic member is provided on each of a first surface and a second surface of the column member, the first surface facing to the connector board, and the second surface facing to the circuit board,
the metallic member on the first surface is connected to the connector board via a solder, and
the metallic member on the second surface is connected to the circuit board via a solder.

9. The circuit module according to claim 8, wherein
a metallic member is also provided on a third surface of the column member that connects the first surface and the second surface.

10. The circuit module according to claim 9, wherein
a metallic member is also provided on a fourth surface of the column member that connects the first surface and the second surface, and
at least a part of a cross-section of the column member in its longitudinal direction is surrounded with the metallic member by providing the metallic members on the first, second, third and fourth surfaces.

11. An electronic device provided with the circuit module according to claim 1.
